(19) United States
(12) Patent Application Publication
(10) Pub. No.: US 2025/0304421 A1
(43) Pub. Date: Oct. 2, 2025

(54) WATER CONTAINER ADAPTER

(71) Applicants: Jianhang WU, Shenzhen City (CN); Minyong XIE, Shenzhen City (CN)

(72) Inventors: Jianhang WU, Shenzhen City (CN); Minyong XIE, Shenzhen City (CN)

(73) Assignees: Jianhang WU, Shenzhen City (CN); Minyong XIE, Shenzhen City (CN); 4R Water Packaging Machinery Limited, Shenzhen (CN)

(21) Appl. No.: 19/238,447

(22) Filed: Jun. 15, 2025

(30) Foreign Application Priority Data
Jun. 21, 2024 (CN) 202421434875.8

(51) Int. Cl. B67D 1/08; B67D 1/00

(52) U.S. Cl. CPC B67D 1/0807; B67D 1/0004; B67D 2001/0812

(57) ABSTRACT

The present invention discloses a water container adapter, comprising an upper connection portion for connecting to a water dispenser. A vertically extending first through hole is provided at the center of the upper connection portion, allowing the dispenser hose to pass through. A first threaded connection portion extends downward from the outer edge of the lower end of the upper connection portion and is provided with a first thread for connecting to a first threaded water outlet; it has a first diameter. A second threaded connection portion extends downward from the central lower end of the upper connection portion and is provided with a second thread for connecting to a second threaded water outlet; it has a second diameter. With this structure, the adapter fitting features a simple design and is compatible with most threaded water outlets on the market, allowing for more convenient and hygienic water dispensing.

### CROSS-REFERENCE TO RELATED APPLICATIONS

This application claims priority of Chinese patent application CN2024214348758, filed on Jun. 21, 2024, which is incorporated herein by reference in its entireties.

### TECHNICAL FIELD

The present invention relates to the technical field of water containers, and more particularly to a novel structure of a water container adapter.

### BACKGROUND OF THE INVENTION

In daily life, barreled water is a common way of water storage. Whether for household use or outdoor activities, people rely on various types of containers to meet their water consumption needs. For everyday household use, electric or manual water dispensers are widely employed to extract water from barreled water containers. These dispensers are typically designed with compatibility in mind to match the opening structure of barreled water containers, thereby simplifying the water extraction process.

For outdoor enthusiasts, dedicated outdoor water containers are often used as water supply devices. However, outdoor water containers are usually equipped only with threaded water outlets, while most commonly available water dispensers on the market are designed to be compatible with standard household barreled water containers. As a result, when water is needed, users are often forced to either tip the water container to pour water or use a hose to draw water from it. Both methods are inconvenient and may allow impurities to enter the water container, contaminating the water source. Moreover, outdoor water containers vary significantly in the size of their outlet threads. Existing water dispensing devices are not well-suited to accommodate such variations, requiring users to carry multiple types of adapter tools. Traditional methods often involve direct contact with the interior of the water container, which compromises hygiene, while other water dispensing devices lack sufficient adaptability to different water container designs.

To address these issues, the present invention provides a water container adapter, which features a simple structure, high compatibility, and improved convenience and hygiene.

### SUMMARY OF THE INVENTION

To overcome the shortcomings of the prior art, the present invention provides an adapter fitting for a barreled water container, which features a simple structure, good adaptability, and improved convenience and hygiene.

The technical solution adopted by the present invention to solve the above-mentioned technical problem is as follows:

A water container adapter, comprising:

An upper connection portion, configured to connect to a water dispenser; the upper connection portion is provided, at its center, with a first through hole that extends vertically through the component, allowing the insertion of a soft hose from the water dispenser;

A first threaded connection portion, formed by a downward extension of the outer edge at the lower end of the upper connection portion and provided with first threads; the first threaded connection portion is configured to connect with a first threaded water outlet and has a first diameter;

A second threaded connection portion, formed by a downward extension of the upper connection portion around the first through hole and provided with second threads; the second threaded connection portion is configured to connect with a second threaded water outlet and has a second diameter.

As an improvement of the present invention, the adapter further comprises a straight-through joint, which is provided with a first threaded connector and a second threaded connector; the first threaded connector is located at the upper end of the second threaded connector and is detachably connected to the second threaded connection portion; the second threaded connector is configured to connect to a third threaded water outlet.

As a further improvement of the present invention, the first threads and the second threads are internal threads, while the first threaded water outlet and the second threaded water outlet are external threaded water outlets. The first threads are threadably connected to the first threaded water outlet, and the second threads are threadably connected to the second threaded water outlet.

As a further improvement, the first threaded connection portion and the second threaded connection portion are concentrically arranged, and the first diameter is greater than the second diameter.

As a further improvement, when the first threaded connector is connected to the second threaded connection portion, the second threaded connector protrudes below the lower edge of both the first and second threaded connection portions.

As a further improvement, the first threaded connector and the second threaded connector are external threads, and the third threaded water outlet is an internal threaded outlet. The first threaded connector is threadably connected to the second threaded connector, and the second threaded connector is configured to be threadably connected to the third threaded water outlet.

An integrated water container adapter, comprising:

An upper connection portion, configured to connect to a water dispenser; the upper connection portion is provided, at its center, with a first through hole extending vertically therethrough, configured to allow a soft hose of the water dispenser to pass through;

A first threaded connection portion, formed by a downward extension of the outer edge of the lower end of the upper connection portion and provided with first threads, configured to connect to a first threaded water outlet, the first threaded connection portion having a first diameter;

A second threaded connection portion, formed by a downward extension surrounding the first through hole on the upper connection portion and provided with second threads, configured to connect to a second threaded water outlet, the second threaded connection portion having a second diameter;

A cap, fitted over the upper end of the upper connection portion, wherein the cap is provided, at its center, with a second through hole extending vertically therethrough, configured to allow the soft hose of the water dispenser to pass through.

As an improvement, the adapter further comprises a straight-through joint, which includes a first threaded connector and a second threaded connector, wherein the first threaded connector is located at the upper end of the second threaded connector, and is detachably connected to the second threaded connection portion; the second threaded connector is configured to connect to a third threaded water outlet.

As a further improvement, the first threads and second threads are internal threads, while the first threaded water outlet and the second threaded water outlet are external threaded water outlets. The first threads are threadably connected to the first threaded water outlet, and the second threads are threadably connected to the second threaded water outlet.

As a further improvement, the first threaded connection portion and the second threaded connection portion are concentrically arranged, and the first diameter is greater than the second diameter.

As a further improvement, when the first threaded connector is connected to the second threaded connection portion, the second threaded connector protrudes beyond the lower edges of both the first threaded connection portion and the second threaded connection portion.

As a further improvement, the first threaded connector and the second threaded connector are external threads, the third threaded water outlet is an internal thread, the first threaded connector is threadably connected to the second threaded connector, and the second threaded connector is configured to be threadably connected to the third threaded water outlet.

A water outlet adapter, comprising:

An upper connection portion, configured to connect to a water dispenser, wherein a first through hole vertically extends through the center of the upper connection portion, and the first through hole allows a soft hose of the water dispenser to pass through;

A first threaded connection portion, formed by a downward extension of the outer edge at the lower end of the upper connection portion and provided with first threads, configured to connect to a first threaded water outlet, the first threaded connection portion having a first diameter;

A second threaded connection portion, formed by a downward extension surrounding the first through hole on the upper connection portion and provided with second threads, configured to connect to a second threaded water outlet, the second threaded connection portion having a second diameter;

A cap, fitted over the upper end of the upper connection portion, wherein the cap is provided at its center with a second through hole extending vertically therethrough, the second through hole allowing the soft hose of the water dispenser to pass through;

A water dispenser, which is provided with a soft hose, and the soft hose passes through the second through hole and the first through hole to enter the water container.

As an improvement of the present invention, the adapter further comprises a straight-through joint, which includes a first threaded connector and a second threaded connector, wherein the first threaded connector is located at the upper end of the second threaded connector and is detachably connected to the second threaded connection portion, and the second threaded connector is configured to connect to a third threaded water outlet.

As a further improvement, the first threads and the second threads are internal threads, while the first threaded water outlet and the second threaded water outlet are external threaded water outlets; the first threads are threadably connected to the first threaded water outlet, and the second threads are threadably connected to the second threaded water outlet.

As a further improvement, the first threaded connection portion and the second threaded connection portion are concentrically arranged, and the first diameter is greater than the second diameter.

As a further improvement, when the first threaded connector is connected to the second threaded connection portion, the second threaded connector protrudes beyond the lower edges of both the first threaded connection portion and the second threaded connection portion.

As a further improvement, the first threaded connector and the second threaded connector are external threads, and the third threaded water outlet is an internal thread; the first threaded connector is threadably connected to the second threaded connector, and the second threaded connector is configured to be threadably connected to the third threaded water outlet.

As a further improvement, the diameter of the first threaded water outlet is 2.05 inches, and the first threads are adapted to the 2.05-inch first threaded water outlet.

As a further improvement, the diameter of the second threaded water outlet and the third threaded water outlet is ¾ inches; the second threads are adapted to the ¾-inch second threaded water outlet, and the second threaded connector is adapted to the ¾-inch third threaded water outlet.

The beneficial effect of the present invention is: through the above structural configuration, the invention provides an adapter for a water container, which has a simple structure and is compatible with most water outlet interfaces on the market, enabling more convenient and hygienic water dispensing.

### BRIEF DESCRIPTION OF DRAWINGS

To clearly illustrate the technical solutions described in the embodiments of the present invention, a brief introduction to the accompanying drawings used in the following description is provided. The drawings below represent only some embodiments of the invention. Those skilled in the art will understand that other drawings may also be derived based on these figures without requiring inventive labor.

The invention will now be further described in conjunction with the accompanying drawings and specific embodiments.

FIG. 1 is a partial structural schematic view of the water container adapter fitting according to the present invention;

FIG. 2 is another partial structural schematic view of the water container adapter fitting according to the present invention;

FIG. 3 is an overall structural schematic view of the water container adapter fitting according to the present invention;

FIG. 4 is an overall structural schematic view of the water outlet adapter according to the present invention;

FIG. 5 is an exploded structural schematic view showing a first usage state of the present invention;

FIG. 6 is an exploded structural schematic view showing a second usage state of the present invention;

FIG. 7 is an exploded structural schematic view showing a third usage state of the present invention.

Description of reference numerals: 100, Water container adapter; 110, Upper connection portion; 111, First through hole; 112, Cavity; 120, First threaded connection portion; 121, First thread; 130, Second threaded connection portion; 131, Second thread; 140, Straight-through joint; 141, First threaded connector; 142, Second threaded connector; 200, Integrated water container adapter; 210, Cap; 211, Second through hole; 300, Water outlet adapter; 310, Water dispenser; 311, Hose; 400, Water container; 410, First threaded water outlet; 420, Second threaded water outlet; 430, Third threaded water outlet.

### DETAILED DESCRIPTION OF THE INVENTION

To make the objectives, features, and advantages of the present application more apparent and easier to understand, the specific embodiments of the present application are described in detail below with reference to the accompanying drawings. In the following description, numerous specific details are set forth to facilitate a thorough understanding of the present application. However, it should be understood that the present application may be practiced in ways other than those specifically described herein. Those skilled in the art can make similar modifications without departing from the spirit of the present application, and therefore, the specific embodiments disclosed below should not be construed as limiting the scope of the present application.

In the description of the present application, it should be understood that terms such as “center,” “longitudinal,” “lateral,” “length,” “width,” “thickness,” “upper,” “lower,” “front,” “rear,” “left,” “right,” “vertical,” “horizontal,” “top,” “bottom,” “inner,” “outer,” “clockwise,” “counterclockwise,” “axial,” “radial,” and “circumferential” refer to the orientation or positional relationships based on the figures. These terms are intended only to facilitate the description and simplification of the drawings and are not meant to indicate or imply that the components or devices must be configured or operated in a particular orientation. Thus, they should not be construed as limiting the present application.

Furthermore, terms such as “first” and “second” are used only for descriptive purposes and should not be interpreted as indicating relative importance or implying any specific quantity of the features referred to. Features described with “first” or “second” may explicitly or implicitly include one or more such features. The term “plurality” as used herein refers to at least two, such as two, three, or more, unless specifically defined otherwise.

Unless expressly specified or limited otherwise, terms such as “mounted,” “connected,” “coupled,” and “fixed” should be interpreted broadly. For example, they may refer to fixed connections, detachable connections, or integral structures; they may be mechanical or electrical connections; they may be direct connections or indirect connections through an intermediate medium; they may involve communication between or interaction of internal components. Those skilled in the art can interpret these terms according to the specific context of the application.

Unless expressly stated otherwise, descriptions of one feature being “on” or “under” another feature may include either direct or indirect contact via an intermediate element. Moreover, “above,” “on top of,” or “upper” may refer to directly above, diagonally above, or merely higher in position than another element. Similarly, “below,” “under,” or “lower” may refer to directly below, diagonally below, or merely lower in position.

If a component is described as “fixed to” or “disposed on” another component, it may be directly on that component or indirectly through an intermediate component. If a component is described as “connected to” another component, it may be directly connected or connected through an intermediate component. Terms such as “vertical,” “horizontal,” “upper,” “lower,” “left,” and “right” are used for illustrative purposes only and should not be regarded as the only implementation or limitation of the invention.

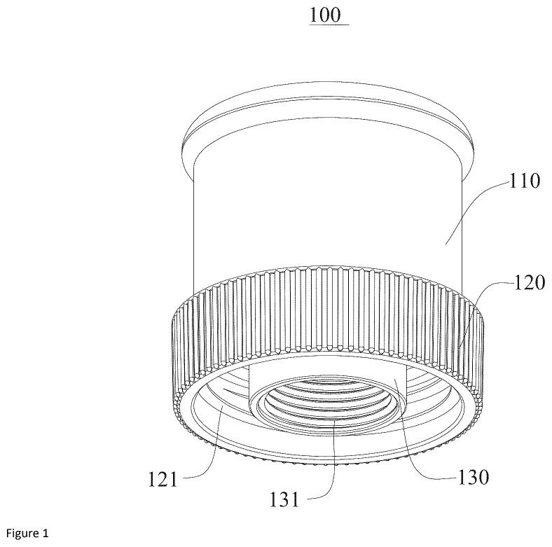

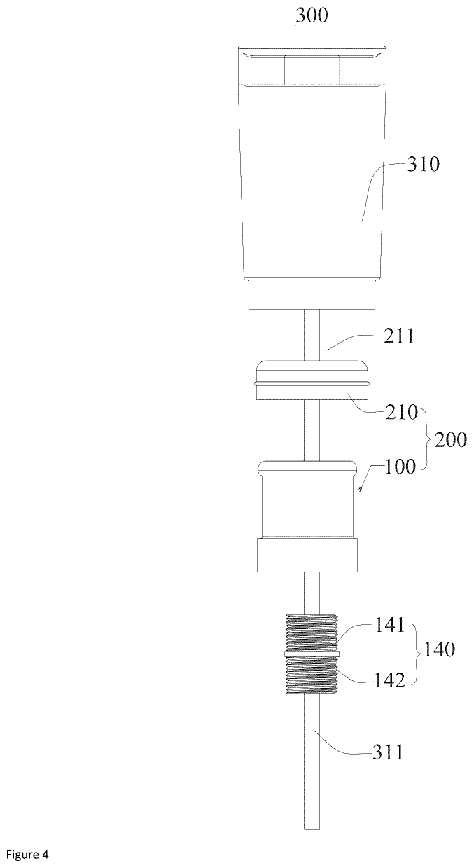

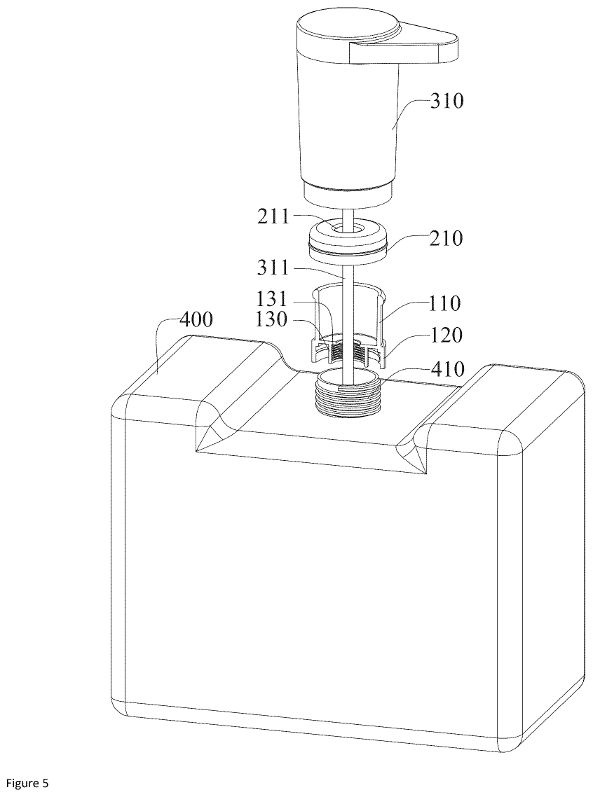

Referring to FIGS. 1 to 7, a water container adapter 100 is provided, including:

An upper connection portion 110, configured to connect to a water dispenser 310. A first through hole 111 is formed centrally in the upper connection portion 110, which allows a hose 311 of the water dispenser 310 to pass through;

A first threaded connection portion 120, extending downward from the outer lower edge of the upper connection portion 110 and provided with a first thread 121. The first threaded connection portion 120 is configured to connect to a first threaded water outlet 410 and has a first diameter;

A second threaded connection portion 130, extending downward around the first through hole 111 and provided with a second thread 131. The second threaded connection portion 130 is configured to connect to a second threaded water outlet 420 and has a second diameter.

With the above structure, the water container adapter 100 is able to accommodate different types of water container outlets. The upper connection portion 110 allows connection with the water dispenser 310 and provides a passage for the hose 311. The first and second threaded connection portions (120 and 130) have different diameters (the first and second diameters, respectively), enabling them to connect to water outlets of different specifications (410 and 420). This integrated and multi-purpose design enhances the device's compatibility and adaptability, meeting the requirements of various usage scenarios. The independent design of the connection portion allows users to quickly select the appropriate threaded connection according to their water container 400's outlet without the need for extra accessories or complex conversion processes, thus improving convenience. This design is especially user-friendly for outdoor enthusiasts, as the adapter 100 can fit most outdoor water containers 400 available on the market. Additionally, it is also compatible with most household water containers 400. During use, the user may connect either the first thread 121 or the second thread 131 to the corresponding water outlet depending on the configuration of the water container 400, thereby establishing a secure connection between the adapter 100 and the water container 400.

An integrated water container adapter 200 is provided, comprising:

An upper connection portion 110, configured to connect to a water dispenser 310, wherein a first through hole 111 is formed centrally in the upper connection portion 110 to allow a hose 311 of the water dispenser 310 to pass through;

A first threaded connection portion 120, formed by a downward extension from the lower outer edge of the upper connection portion 110 and provided with a first thread 121, the first threaded connection portion 120 being configured to connect to a first threaded water outlet 410, and having a first diameter;

A second threaded connection portion 130, formed by a downward extension surrounding the first through hole 111 and provided with a second thread 131, the second threaded connection portion 130 being configured to connect to a second threaded water outlet 420, and having a second diameter;

A cap 210, fitted over the upper end of the upper connection portion 110, wherein a second through hole 211 is formed centrally in the cap 210 to allow the hose 311 of the water dispenser 310 to pass through.

With the above structural design, the cap 210 is fitted onto the upper end of the water container adapter 100, effectively sealing the top opening of the adapter 100 during both usage and non-usage states. This prevents external impurities, dust, or contaminants from entering the cavity 112 of the upper connection portion 110, and also reduces cleaning difficulty when the adapter 100 is not in use. The second through hole 211 in the cap 210 allows the hose 311 of the water dispenser to pass through smoothly. Accordingly, during water extraction, the cap 210 can remain in place on the upper connection portion 110, which helps to stabilize the position of the hose 311 during assembly. This enhances the overall functional integrity and operational safety of the structure. Moreover, the second through hole 211 serves as a guide for proper hose installation, simplifying the assembly and disassembly processes, thereby improving user convenience and maintenance efficiency.

Preferably, the cap 210 may be the original lid of the water container 400. For example, some five-gallon water containers are already designed with a built-in through hole, which allows the original container lid to be used directly as the cap 210, thereby simplifying the structure and reducing manufacturing cost.

Preferably, the dimensions of the cap 210 are matched to those of the upper connection portion 110. This structural compatibility ensures a tight fit, improving stability and sealing performance during use, and prevents loosening or misalignment that could lead to failure of the cover.

Preferably, the upper connection portion 110 is provided with a cavity 112, which is in communication with the first through hole 111. With this configuration, the cap 210 designed as insert-type structures may partially extend into the cavity 112, thus ensuring smooth and sealed connections. Additionally, when not in use, a portion of the hose 311 may be stored inside the cavity 112.

Preferably, the upper end of the upper connection portion 110 adopts an open-mouth design. This facilitates detachable insertion of the cap 210 into the cavity 112, improving cleanability of the internal space of the upper connection portion 110 during use or maintenance. This also reduces hygiene risks caused by residual liquids and further enhances the safety and service life of the water container adapter 100.

A water outlet adapter 300, comprising:

An upper connection portion 110 configured to connect to a water dispenser 310, wherein a vertically through first through hole 111 is formed in the middle of the upper connection portion 110, the first through hole 111 allowing a hose 311 of the water dispenser 310 to pass through;

A first threaded connection portion 120, wherein the lower outer edge of the upper connection portion 110 extends downward to form the first threaded connection portion 120 with a first thread 121, the first threaded connection portion 120 being used to connect with a first threaded water outlet 410, and having a first diameter;

A second threaded connection portion 130, wherein the upper connection portion 110 extends downward around the first through hole 111 to form the second threaded connection portion 130 with a second thread 131, the second threaded connection portion 130 being used to connect with a second threaded water outlet 420, and having a second diameter;

A cap 210, which is fitted to the upper end of the upper connection portion 110, wherein a vertically through second through hole 211 is formed in the center of the cap 210, the second through hole 211 allowing the hose 311 of the water dispenser 310 to pass through;

A water dispenser 310 provided with a hose 311, the hose 311 passing through the second through hole 211 and the first through hole 111 to enter a water container 400.

With the above configuration, the water dispenser 310 and its hose 311 serve as the main medium for water flow. The water dispenser 310, in conjunction with the water container adapter 100, enables users to extract water steadily during outdoor use. The cap 210 ensures hygiene during the water extraction process.

In this embodiment, the adapter further comprises a straight-through joint 140 having a first threaded connector 141 and a second threaded connector 142. The first threaded connector 141 is located at the upper end of the second threaded connector 142 and is removably connected to the second threaded connection portion 130. The second threaded connector 142 is configured to connect to a third threaded water outlet 430.

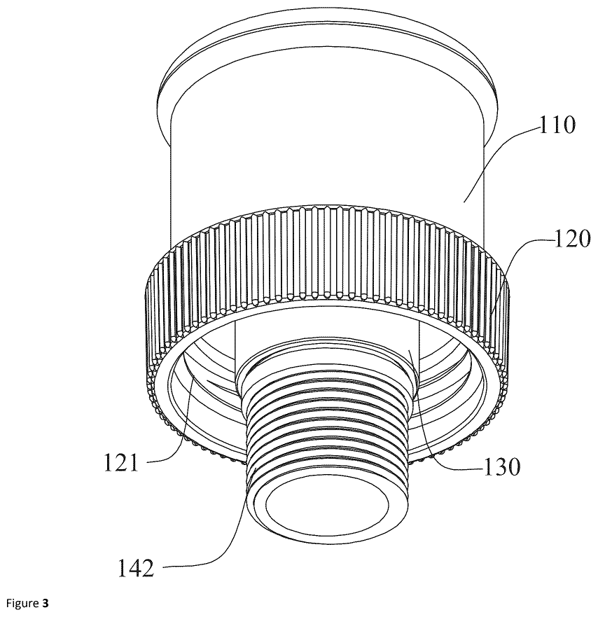

As shown in FIG. 3, the straight-through joint 140 is provided with the first threaded connector 141 and the second threaded connector 142, which are respectively connected to the second threaded connection portion 130 of water container adapter 100 and to a water container 400 having the third threaded water outlet 430. During use: If the water outlet of the water container 400 is an internal thread, the second threaded connector 142 of the straight-through joint 140 is first connected to the third threaded water outlet 430, then the first threaded connector 141 is connected to the second thread 131 of the second threaded connection portion 130, and finally the hose 311 of the water dispenser 310 is sequentially passed through the second through hole 211, the first through hole 111, and the straight-through joint 140 to enter the water container 400, thereby enabling rapid water extraction from water containers with internally threaded water outlets; If the water outlet of the water container 400 is an external thread, the user may select either the first threaded water outlet 410 or the second threaded water outlet 420 depending on the size of the outlet on the water container 400, and connect either the first thread 121 or the second thread 131 accordingly. Then, the hose 311 of the water dispenser 310 is sequentially passed through the second through hole 211 and the first through hole 111 to enter the water container 400, thus enabling quick water access for externally threaded water containers.

In this embodiment, the first thread 121 is an internal thread, and the first threaded water outlet 410 is an external thread. The first thread 121 is threadably connected to the first threaded water outlet 410. This configuration enables fast and secure connection with most commercially available water containers 400, enhancing the compatibility and user-friendliness of the water container adapter 100.

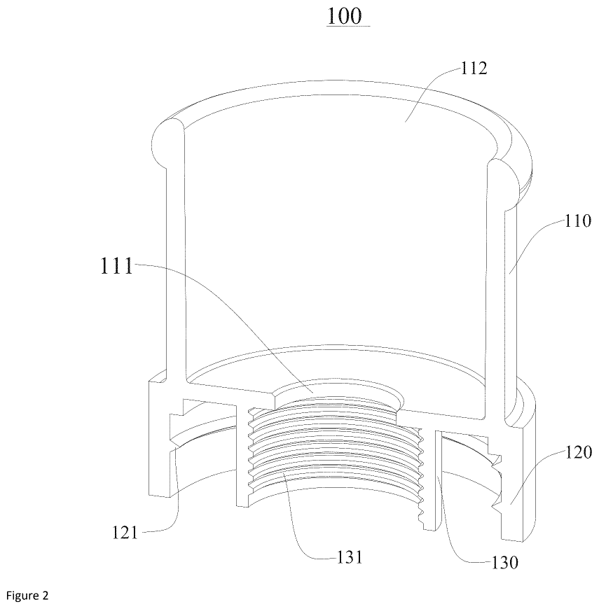

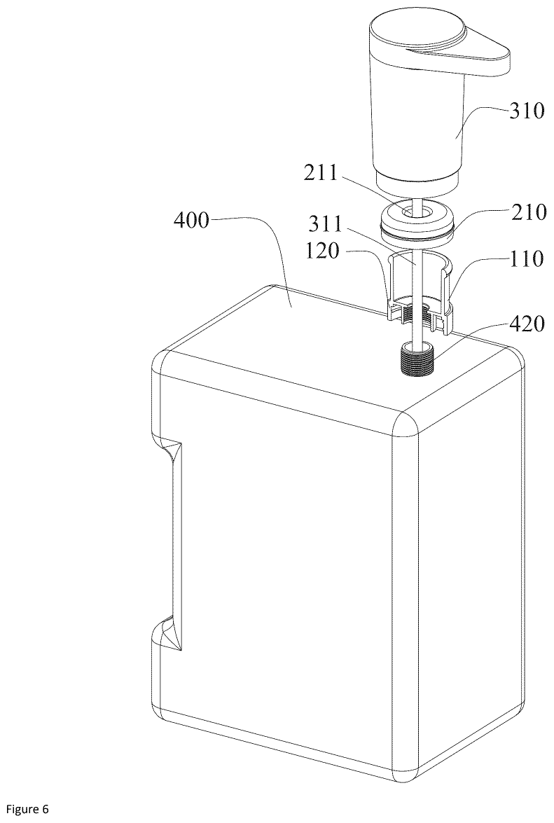

In this embodiment, the second thread 131 is an internal thread, and the second threaded water outlet 420 is an external thread. The second thread 131 is threadably connected to the second threaded water outlet 420. With this configuration, as shown in FIGS. 2 and 6, by providing the second thread 131 as an internal thread and mating it with the externally threaded second water outlet 420, the adapter achieves enhanced adaptability to different models of barreled water containers 400 and improves the stability and seal integrity of the connection between the water container 400 and the water container adapter 100. This design improves overall structural reliability and broadens the applicability of the water container adapter 100, making it easy for users to flexibly install or switch adapters according to their specific water container outlet, thus enhancing convenience and adaptability.

In this embodiment, the first diameter is greater than the second diameter. As shown in FIG. 1, since the first diameter exceeds the second, the first threaded connection portion 120 is larger overall than the second threaded connection portion 130. The water container adapter 100 is thus formed as a whole with the second threaded connection portion 130 nested inside the first threaded connection portion 120. This nested design saves space and increases compactness, while providing greater flexibility and stability when adapting to differing water container outlet specifications. Additionally, the concentric internal/external nesting helps improve centering during connection to the water container 400, preventing leakage at the joint, thereby enhancing safety and reliability during water dispensing.

In this embodiment, the first threaded connection portion 120 and the second threaded connection portion 130 are concentrically arranged. With a common axis, the water container adapter 100 achieves structural balance, smooth water flow, and efficient transfer. The concentric layout also enhances assembly stability and sealing, avoiding stress concentrations, poor seals, or installation issues that could result from eccentric alignment.

In this embodiment, when the first threaded connector 141 is connected to the second threaded connection portion 130, the second threaded connector 142 protrudes below the lower edge of both the first and second threaded connection portions. As shown in FIG. 3, the straight-through joint 140 is integrally designed, forming a stable fluid passage between the first threaded connector 141 and the second threaded connector 142, preventing leakage risks typical with traditional two-piece structures. The integrated structure simplifies assembly and enhances long-term stability and durability of the straight-through joint 140. With the second threaded connector 142 extending beyond the lower edges, connection to the water container 400 is made easier, and coupling/disassembly with the second threaded connection portion 130 becomes faster and more reliable—resulting in efficient, dependable, and maintenance-friendly operation.

In this embodiment, the first threaded connector 141 is external threaded, and it is threadably connected to the second thread 131. This external-to-internal thread match ensures tight coupling, ease of assembly/disassembly, and excellent sealing. The threaded connection enhances connection stability and load-bearing capability, and allows users to quickly replace or maintain components, improving overall practicality and adaptability. Moreover, this mating of internal and external threads improves guidance and alignment during assembly, further safeguarding fluid transmission safety and reliability.

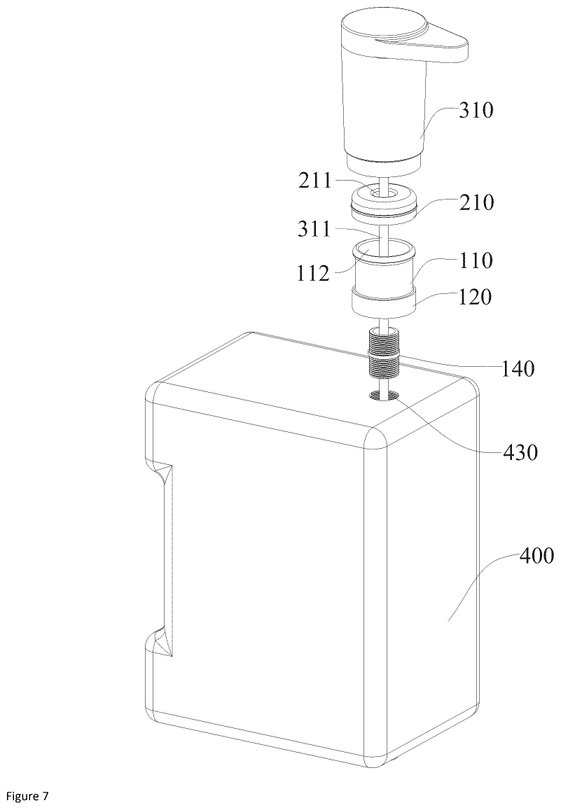

In this embodiment, the second threaded connector 142 is external threaded, and the third threaded water outlet 430 is internal threaded. The second threaded connector 142 is adapted to threadably connect to the third threaded water outlet 430. As shown in FIG. 7, for water containers 400 whose third water outlet 430 is designed with internal threading, this second threaded connector 142 of the straight-through joint serves as a bridge with matching external threads. The connection process involves first coupling the second threaded connector 142 to the third threaded water outlet 430, whereupon the first threaded connector 141 protrudes slightly above the plane of the water outlet. Then the first threaded connector 141 is threadably coupled to the second thread 131 of the second threaded connection portion 130, thus completing the connection of the straight-through joint 140 to the water container adapter 100.

In this embodiment, the first threaded water outlet 410 has a diameter of 2.05 inches, and the first thread 121 is adapted for a 2.05-inch outlet. Since a large portion of water containers 400 on the market have external threads of this diameter, the first thread 121 is designed as a 2.05-inch internal thread for effective coupling. Preferably, to accommodate non-standard threads commonly found in Chinese containers, the thread pitch count is reduced, allowing suitability for ϕ50-ϕ54 mm threads, thus enhancing the universality of the first threaded connection portion 120.

In this embodiment, the second threaded water outlet 420 has a diameter of ¾ inches, and the second thread 131 is designed accordingly. Because some water containers 400 feature ¾-inch external thread outlets, the second thread 131 must match them for proper water access. Preferably, the thread pitch count may also be reduced to accommodate non-standard outlets.

In this embodiment, the third threaded water outlet 430 also has a diameter of ¾ inches, and the second threaded connector 142 is adapted accordingly. For water container 400 with ¾-inch internal thread outlets, the procedure involves first coupling the second threaded connector 142 to the third outlet 430, then coupling the first threaded connector 141 to the second thread 131 of the water container adapter 100—thus enabling water dispensing from ¾-inch internal outlets.

Preferably, the hose 311 is dimensionally matched to the second through hole 211, the first through hole 111, and the straight-through joint 140. The hose 311 plays a critical role in guiding and transmitting fluid during the user's water extraction. One end of the hose rests inside the water container 400 under the liquid surface to ensure suction, while the other end passes through the second through hole 211, first through hole 111, and straight-through joint 140 to connect with the water dispenser 310, enabling the user to draw water smoothly and efficiently. Proper sizing with respect to these passages ensures smooth installation and dispensing, good sealing, and prevents leakage, clogging, or unstable flow during transmission.

The above-described embodiments are provided solely in connection with specific details and are not intended to limit the scope of the invention. Any methods, structures, or equivalents that are similar or based on the inventive concept described herein, or derived through technical modifications or substitutions, shall fall within the scope of this invention.

1. A water container adapter (100), characterized in that it comprises:
an upper connection portion (110), the upper connection portion (110) being configured to connect to a water dispenser (310), wherein a first through hole (111) is formed through the center of the upper connection portion (110) in a vertical direction, and the first through hole (111) is configured to allow a hose (311) of the water dispenser (310) to pass through;
a first threaded connection portion (120), the upper connection portion (110) extending downward around the first through hole (111) to form the first threaded connection portion (120) with a first thread (121), the first threaded connection portion (120) being configured to connect to a first threaded water outlet (410) and having a first diameter;
a second threaded connection portion (130), the lower central portion of the upper connection portion (110) extending downward to form the second threaded connection portion (130) with a second thread (131), the second threaded connection portion (130) being configured to connect to a second threaded water outlet (420) and having a second diameter.

2. The water container adapter (100) according to claim 1, characterized in that it further comprises a straight-through joint (140), the straight-through joint (140) being provided with a first threaded connector (141) and a second threaded connector (142), the first threaded connector (141) being disposed at the upper end of the second threaded connector (142), the first threaded connector (141) being detachably connected to the second threaded connection portion (130), and the second threaded connector (142) being configured to connect to a third threaded water outlet (430).

3. The water container adapter (100) according to claim 1, characterized in that the first thread (121) and the second thread (131) are internal threads, the first threaded water outlet (410) and the second threaded water outlet (420) are external threaded water outlets, the first thread (121) is threadably connected to the first threaded water outlet (410), and the second thread (131) is threadably connected to the second threaded water outlet (420).

4. The water container adapter (100) according to claim 1, characterized in that the first threaded connection portion (120) and the second threaded connection portion (130) are arranged concentrically, and the first diameter is greater than the second diameter.

5. The water container adapter (100) according to claim 3, characterized in that when the first threaded connector (141) is connected to the second threaded connection portion (130), the second threaded connector (142) protrudes beyond the lower edges of both the first threaded connection portion (120) and the second threaded connection portion (130).

6. The water container adapter (100) according to claim 5, characterized in that the first threaded connector (141) and the second threaded connector (142) are external threads, the third threaded water outlet (430) is an internal thread, the first threaded connector (141) is threadably connected to the second thread (131), and the second threaded connector (142) is configured to be threadably connected to the third threaded water outlet (430).

7. A integrated water container adapter (200), characterized in that it comprises:
an upper connection portion (110), the upper connection portion (110) being configured to connect to a water dispenser (310), wherein a first through hole (111) is formed through the center of the upper connection portion (110) in a vertical direction, and the first through hole (111) is configured to allow a hose (311) of the water dispenser (310) to pass through;
a first threaded connection portion (120), the upper connection portion (110) extending downward around the first through hole (111) to form the first threaded connection portion (120) with a first thread (121), the first threaded connection portion (120) being configured to connect to a first threaded water outlet (410) and having a first diameter;
a second threaded connection portion (130), the lower central portion of the upper connection portion (110) extending downward to form the second threaded connection portion (130) with a second thread (131), the second threaded connection portion (130) being configured to connect to a second threaded water outlet (420) and having a second diameter;
a cap (210), the cap (210) being secured over the upper end of the upper connection portion (110), and a second through hole (211) is formed through the center of the cap (210) in a vertical direction, the second through hole (211) being configured to allow the hose (311) of the water dispenser (310) to pass through.

8. The integrated water container adapter (200) according to claim 7, characterized in that it further comprises a straight-through joint (140), which is provided with a first threaded connector (141) and a second threaded connector (142), the first threaded connector (141) being disposed at the upper end of the second threaded connector (142), the first threaded connector (141) being detachably connected to the second threaded connection portion (130), and the second threaded connector (142) being configured to connect to a third threaded water outlet (430).

9. The integrated water container adapter (200) according to claim 7, characterized in that the first thread (121) and the second thread (131) are internal threads, the first threaded water outlet (410) and the second threaded water outlet (420) are external threaded water outlets, the first thread (121) is threadably connected to the first threaded water outlet (410), and the second thread (131) is threadably connected to the second threaded water outlet (420).

10. The integrated water container adapter (200) according to claim 7, characterized in that the first threaded connection portion (120) and the second threaded connection portion (130) are arranged concentrically, and the first diameter is greater than the second diameter.

11. The integrated water container adapter (200) according to claim 9, characterized in that when the first threaded connector (141) is connected to the second threaded connection portion (130), the second threaded connector (142) protrudes beyond the lower edges of both the first threaded connection portion (120) and the second threaded connection portion (130).

12. The integrated water container adapter (200) according to claim 11, characterized in that the first threaded connector (141) and the second threaded connector (142) are external threads, the third threaded water outlet (430) is an internal thread, the first threaded connector (141) is threadably connected to the second thread (131), and the second threaded connector (142) is configured to be threadably connected to the third threaded water outlet (430).

13. A water outlet adapter (300), characterized in that it comprises:
an upper connection portion (110), the upper connection portion (110) being configured to connect to a water dispenser (310), wherein a first through hole (111) is formed through the center of the upper connection portion (110) in a vertical direction, and the first through hole (111) is configured to allow a hose (311) of the water dispenser (310) to pass through;
a first threaded connection portion (120), the upper connection portion (110) extending downward around the first through hole (111) to form the first threaded connection portion (120) with a first thread (121), the first threaded connection portion (120) being configured to connect to a first threaded water outlet (410) and having a first diameter;
a second threaded connection portion (130), the lower central portion of the upper connection portion (110) extending downward to form the second threaded connection portion (130) with a second thread (131), the second threaded connection portion (130) being configured to connect to a second threaded water outlet (420) and having a second diameter;
a cap (210), the cap (210) being secured over the upper end of the upper connection portion (110), and a second through hole (211) is formed through the center of the cap (210), the second through hole (211) being configured to allow the hose (311) of the water dispenser (310) to pass through;
a water dispenser (310), the water dispenser (310) being provided with a hose (311), the hose (311) passing through the second through hole (211) and the first through hole (111) to enter the water container (400).

14. The water outlet adapter (300) according to claim 13, characterized in that it further comprises a straight-through joint (140), which is provided with a first threaded connector (141) and a second threaded connector (142), the first threaded connector (141) being disposed at the upper end of the second threaded connector (142), the first threaded connector (141) being detachably connected to the second threaded connection portion (130), and the second threaded connector (142) being configured to connect to a third threaded water outlet (430).

15. The water outlet adapter (300) according to claim 13, characterized in that the first thread (121) and the second thread (131) are internal threads, the first threaded water outlet (410) and the second threaded water outlet (420) are external threaded water outlets, the first thread (121) is threadably connected to the first threaded water outlet (410), and the second thread (131) is threadably connected to the second threaded water outlet (420).

16. The water outlet adapter (300) according to claim 13, characterized in that the first threaded connection portion (120) and the second threaded connection portion (130) are arranged concentrically, and the first diameter is greater than the second diameter.

17. The water outlet adapter (300) according to claim 15, characterized in that when the first threaded connector (141) is connected to the second threaded connection portion (130), the second threaded connector (142) protrudes beyond the lower edges of both the first threaded connection portion (120) and the second threaded connection portion (130).

18. The water outlet adapter (300) according to claim 17, characterized in that the first threaded connector (141) and the second threaded connector (142) are external threads, the third threaded water outlet (430) is an internal thread, the first threaded connector (141) is threadably connected to the second thread (131), and the second threaded connector (142) is configured to be threadably connected to the third threaded water outlet (430).

19. The water outlet adapter (300) according to claim 15, characterized in that the diameter of the first threaded water outlet (410) is 2.05 inches, and the first thread (121) is adapted to the 2.05-inch first threaded water outlet (410).

20. The water outlet adapter (300) according to claim 18, characterized in that the diameters of the second threaded water outlet (420) and the third threaded water outlet (430) are ¾ inches, the second thread (131) is adapted to the ¾-inch second threaded water outlet (420), and the second threaded connector (142) is adapted to the ¾-inch third threaded water outlet (430).
